(19) United States
(12) Patent Application Publication
(10) Pub. No.: US 2017/0275140 A1
(43) Pub. Date: Sep. 28, 2017

(54) Three-power hybrid energy saving system of a rubber tyred gantry crane

(71) Applicant: Shenzhen Zhaohan Technology Development Co., Ltd., Shenzhen City (CN)

(72) Inventors: Ruixian ZHANG, Shenzhen City (CN); Tonghui AN, Shenzhen City (CN); Kai JIA, Shenzhen City (CN); Pu HUANG, Shenzhen City (CN); Zhiming YANG, Shenzhen City (CN); Jinlian LU, Shenzhen City (CN)

(21) Appl. No.: 15/463,241

(22) Filed: Mar. 20, 2017

(30) Foreign Application Priority Data
Mar. 24, 2016 (CN) 201610176361.0
Mar. 24, 2016 (CN) 201620233421.3

(51) Int. Cl. B66C 13/22; B60W 20/00; B66C 13/12

(52) U.S. Cl. CPC B66C 13/22; B66C 13/12; B60W 20/00; B66C 19/00

(57) ABSTRACT

A rubber tyred gantry crane three-power hybrid energy saving system comprising a system controller; a unidirectional AC/DC converter; a small diesel generator set having its output going to the unidirectional AC/DC converter and supplying power to a direct-current bus after rectification; a unidirectional DC/AC inverter power supply having its input end connected in parallel with the direct-current bus, and having output going to the auxiliary transformer after inversion; a battery set and its management system; an interconnection switch; a large diesel generator set; and an auxiliary transformer. Electrical equipment mainly includes a hoist frequency converter, a trolley frequency converter, a gantry frequency converter, auxiliary electrical equipment and a control power supply. The battery set and its management system are connected in parallel with the direct-current bus, provide operating power to the gantry frequency converter, the hoist frequency converter and the trolley frequency converter, and recover the feedback energy of the system.

### RELATED APPLICATIONS

This application claims the benefit of priority to Chinese patent application number CN201610176361.0, filed on Mar. 24, 2016 and Chinese patent application number CN201620233421.3, filed on Mar. 24, 2016, the entire contents of each are incorporated herein by reference.

### TECHNICAL FIELD

The present invention relates to a terminal equipment power system, belonging to the field of new energy applications, and in particular to a three-power hybrid energy saving system for a rubber tyred gantry crane (RTG).

### BACKGROUND

The defects of traditional RTGs:

A traditional rubber tyred gantry crane uses a single generator set as power, in which the power of a diesel engine is usually greater than 400 kW, and the fuel efficiency is less than 30%. The main reasons thereof are as follows:

a) Large installed capacity: Since the demand of the short-term peak load of the RTG must be met, the power of the generator set has to be designed based on the highest demand of the RTG, and is about 8 times larger than the average full-load power of the RTG.

b) Low fuel efficiency: When the diesel engine operates in the best economical fuel consumption zone, the fuel consumption will be the lowest. When the RTG is under operation, in order to ensure normal power supply for the control system and the work mechanism, the output power of the generator set must be larger than the required power of the RTG, and the generator set needs to run at a rated speed without interruption. Since the power demands of the RTG are different under different operating conditions, the generator set needs to adjust the output power in real time to make it match with the power demand. Most of the time, the diesel engine operates away from the best economical fuel consumption zone, such that the energy efficiency is low. As the section A of the universal characteristic curve of the diesel engine shown in FIG. 2, when the output power of the engine is about 240 kW at a speed of 1,200-1,300 rpm, fuel consumption is lowest, being 186 g/kWh—called “the best economical fuel consumption zone”. When the power demand of the system is decreased to lower than 40 kW, the fuel consumption reaches up to 426 g/kWh (section B in FIG. 2), which is 2.3 times of “the best economical fuel consumption”; and when the RTG lifts up heavy load and accelerates, the engine often exhausts black smoke due to poor fuel combustion, causing serious pollution.

c) No braking energy recovery function: When the hoisting mechanism of the RTG drops, and the mechanisms for trolley travelling and gantry moving decelerate and brake, without energy storage device, it may result in that the feedback energy cannot be stored and has to be consumed in real time by a power resistor.

The defects of prior hybrid power RTGs:

As traditional rubber tyred gantry crane has very low energy efficiency and obvious shortcomings, in recent years, with the development and application of power batteries, the hybrid power RTGs of various forms gradually come out. There are some representatives of the hybrid power RTGs: dual-power RTGs with “large-capacity battery set+high-power generator set”, extended-range hybrid power RTGs with “large-capacity battery set+low-power generator set”, and superimposed power hybrid power RTGs with “small-capacity battery set+low-power generator set”.

The energy consumption problems are solved in varying degrees by various forms of hybrid power RTGs, and the fuel saving rate can reach up to about 40%-60%. However, since operating conditions of the RTGs are ever-changing, the existing hybrid power RTGs still have the following defects:

a) The power of diesel generator set is still too large: The load weight and the time interval between individual operating cycles are different, resulting in that the actual average power of each work group is different, and the designed output power of the hybrid power system must be larger than the power requirements of full load and the maximum operating cycle frequency, therefore, the power of the diesel generator set of existing hybrid power systems is still too large, such that it is difficult to ensure long-term operating under the best energy efficiency of the diesel engines.

b) Dual-power hybrid power RTGs with “large-capacity battery set+high-power generator set” uses a battery set as its main power source to control the diesel engine to work intermittently. Once started, the diesel engine operates effectively, achieving relatively high energy efficiency. However, the battery needs “deep charging and deep discharging”, which requires high battery performances; and the high-power diesel engine is started frequently, such that the fault points will increase.

c) It is difficult to promote: RTGs are expensive. The users put the reliability of the equipment in the first place. However, the application technology of the power battery is still in the development stage, and the failure rate is relatively high. The users are cautious about choosing oil-electric hybrid power systems. Furthermore, for the transformation of the old equipment, most hybrid power systems require replacing the original generator set, but the users' enthusiasm for the transformation is not high, due to fact that: i) the removed old generator set is not easy to dispose; and ii) there is a risk of increasing failure.

### SUMMARY

Various embodiments include methods of offloading UE communication traffic between communications drones.

The technical problem to be solved in the invention is to provide a three-power hybrid energy saving system for a rubber tyred gantry crane, aiming at improving the reliability of the equipment, reducing energy consumption, and increasing the feasibility of promoting the generalization of old equipment transformation, wherein, the power supply mode of using a single generator set or “a generator set+a battery set” of the RTG is changed, a set of hybrid power system, consisting of “a small-power generator set+a large-capacity battery set”, is added to supply power for the RTG on the premise of not changing the power system of a conventional RTG, such that the “three-power hybrid” RTG is formed, in which the equipment is powered by “a small generator set, a large-capacity battery set and a large generator set”.

The present invention is implemented by the following technical solutions: a three-power hybrid energy saving system for a rubber tyred gantry crane, which is characterized by comprising a system controller, a small diesel generator set, a unidirectional AC/DC converter, a unidirectional DC/AC inverter power supply, a battery set and its management system, an interconnection switch, a large diesel generator set, and an auxiliary transformer. Electrical equipment of the rubber tyred gantry crane, associated with the three-power hybrid energy saving system mainly includes: a hoist frequency converter, a trolley frequency converter, a gantry frequency converter, an auxiliary electrical equipment, and a control power supply; the small diesel generator set outputs to the unidirectional AC/DC converter, after rectification, it supplies power to the direct current bus (DC BUS); and the input end of the unidirectional DC/AC inverter power supply is connected in parallel with the direct current bus, after inversion, it outputs to the auxiliary transformer; and the battery set and its management system are connected in parallel with the direct current bus, to provide operating power to the gantry frequency converter, the hoist frequency converter and the trolley frequency converter, and to recover the feedback energy of the three-power hybrid energy saving system.

As a preferred technical scheme, the small diesel generator set and the large diesel generator set can be independently or simultaneously started, and supply power together with the battery set to the crane.

As a preferred technical scheme, the output power of the small diesel generator set is smaller than the average power under a full load and the highest operating cycle frequency. The small diesel generator set operates for a long time or intermittently at an economic speed and outputs rated power. The final energy consumption is not influenced no matter the power of the small diesel generator set is greater than or less than the maximum actual average power. The optional power of the small diesel generator set is in the range of 15˜75 kW.

As a preferred technical scheme, one path of output of the large diesel generator set is directly connected to the alternating current input end of the hoist frequency converter, and supplies power to the direct current bus after rectification. Another path of output of the large diesel generator set is connected to the interconnection switch.

The design features, working principle and main control logic of the present invention are described below:

a) The large and the small diesel generator sets, can output power separately or simultaneously and supply power together with the battery set to the equipment, thus forming the “three-power hybrid” system of the equipment; the battery set and the large diesel generator set can support operation independently; the small power diesel generator set is not required to be configured according to the average power under the maximum load and the highest operating cycle frequency, but can be designed only according to the average power under an average load and an average operating cycle frequency.

b) Usually, when the equipment is operating, the large generator set is in an OFF state, the small diesel generator set outputs rated power and achieves the best energy efficiency, wherein the insufficient power is supplemented by the battery set, and the output power of the system is highly matched with required power.

c) When the actual dynamic average power is less than the rated power of the small diesel generator set, the surplus energy output from the small generator set charges the battery set. When the battery capacity reaches the set upper limit, the diesel engine is turned off, and the power is supplied only by the battery set. When the battery set discharges to the set lower limit, the small generator set is restarted.

d) Occasionally, when the actual average power is greater than the rated power of the small diesel generator set, the output power of the small generator set is insufficient, resulting in that the battery set feeds electricity. When the fed electricity quantity reaches the set value, the large generator is started to directly supply power to the RTG, and the surplus energy charges the battery set. When the battery capacity reaches the set value, the large diesel generator set is turned off.

e) When the battery set fails, the large diesel generator set is started, and it turns into operation in a traditional mode, requiring no rush-repairing; and the large diesel generator set plays a role of emergency protection under a heavy load and particularly frequent operating cycle, improving the reliability of the equipment.

f) The battery set may support operation independently, which not only meets the maximum power requirements, but also achieves full energy recovery and recycling, thus improving energy efficiency.

The advantages of the invention are: the power of the diesel small generator set can be designed according to the average power requirement of actual operation. Usually, when the equipment is operating, the large diesel generator set is turned off, while the small diesel generator set outputs the rated power, and the insufficient power is supplemented by the battery set. The output power of the system is highly matched with the required power, and the best energy efficiency is achieved. When the operation is busy or the load is relatively heavy, and the actual average power demand is larger than the power of the small diesel generator set such that the battery set feeds electricity, the large diesel generator set is started to directly supply power to the equipment, and the surplus energy charges the battery set. The battery set can achieve full recovery of feedback energy. The original power system is basically unchanged when used in the transformation of the old equipment.

### BRIEF DESCRIPTION OF THE DRAWINGS

In order to illustrate the embodiments of the present invention or the technical solutions in the prior art more clearly, the drawings which are required to be used in description of the embodiments or the prior art will be briefly described below. It will be apparent that the drawings in the following description merely illustrate some embodiments of the present invention. The skilled person of the same art can obtain other drawings based on these drawings without creative work.

FIG. 1 is a schematic diagram of the three-power hybrid energy saving system according to various embodiments.

FIG. 2 is a universal characteristic curve of a diesel engine according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

All of the features or steps in all of the methods or the processes disclosed in this specification can be combined in any manner, other than the mutually exclusive features and/or steps.

Any feature disclosed in this specification (including any additional claims, abstract and drawings) may be replaced by other equivalent or alternative feature having a similar purpose, unless specifically stated otherwise. That is, each feature is merely one example of a series of equivalent or similar features, unless specifically stated.

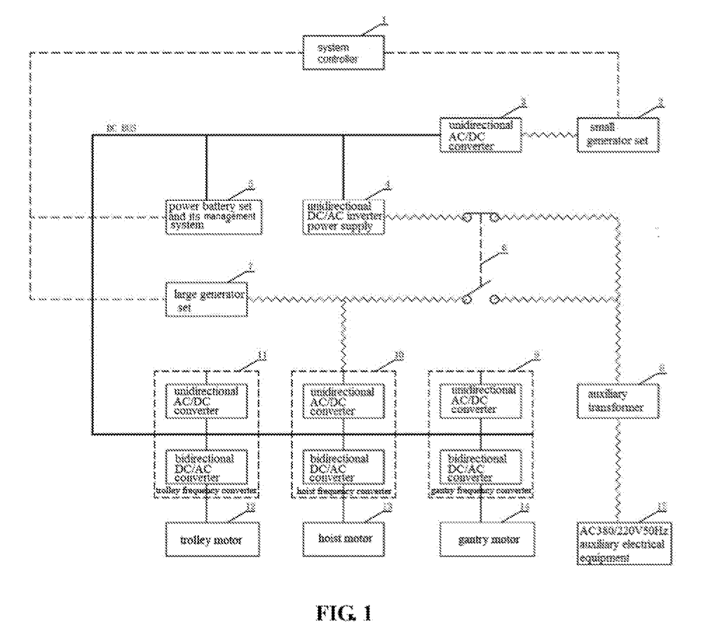

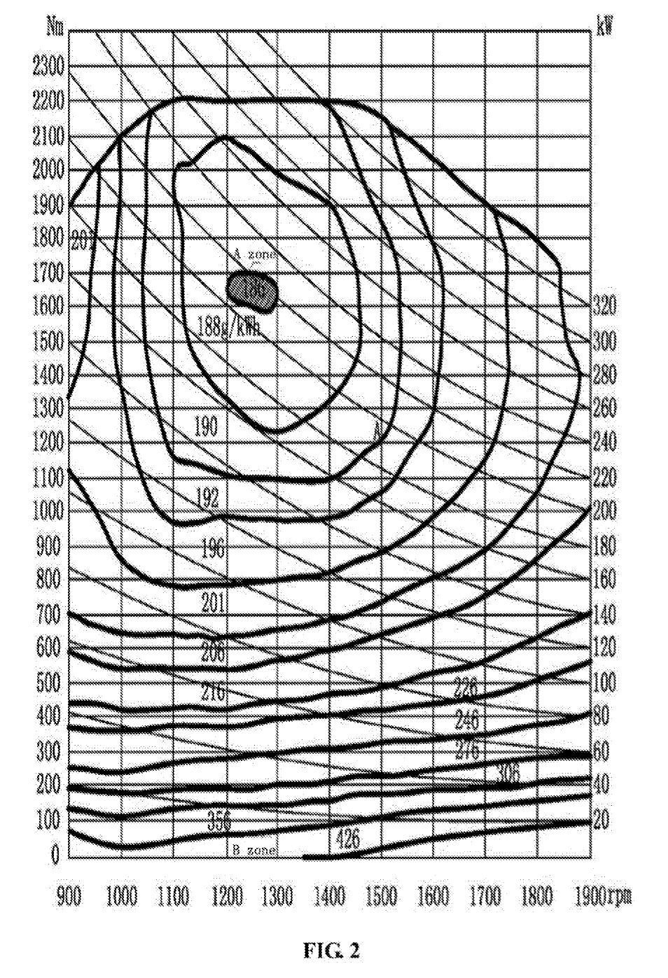

As shown in FIGS. 1 and 2, the system includes: a system controller 1, a small diesel generator set (small generator set) 2, a unidirectional AC/DC converter 3, a unidirectional DC/AC inverter power supply 4, a battery set (power battery set) and its management system 5, an interconnection switch 6, a large diesel generator set (large generator set) 7 and an auxiliary transformer 8. The electrical equipment of the RTG associated with the system mainly includes: a gantry frequency converter 9, a hoist frequency converter 10, a trolley frequency converter 11, a trolley motor (trolley moving mechanism motor) 12, a hoist motor (hoist mechanism motor) 13, a gantry motor (gantry moving mechanism motor) 14 and auxiliary electrical equipment 15, etc., wherein, the large diesel generators set 7, the auxiliary transformer 8, the gantry frequency converter 9, the hoist frequency converter 10, the trolley frequency converter 11, the trolley motor 12, the hoist motor 13, the gantry motor 14 and the auxiliary electrical equipment 15 are the same as the original equipment, and there is no need to make any changes for the old equipment transformation project; the system controller 1, the small diesel generator set 2, the unidirectional AC/DC converter 3, the unidirectional DC/AC inverter power supply 4 and the battery set and its management system 5 form a hybrid power system consisting of a small generator set and a battery set. The interconnection switch 6 is turned on only when the large generator set is turned into the traditional operation mode, and the auxiliary electrical equipment is turned to be powered directly by the large generator set.

Circuit connection manner and principle: the output of the small diesel generator set 2 is connected to the unidirectional AC/DC converter 3, and supplies power to the direct current bus (DC BUS) after rectification; the unidirectional DC/AC inverter power supply 4, with its input end connected in parallel with the direct current bus, after inversion, it outputs to the auxiliary transformer 8, and is transformed to AC380V 50 Hz standard three-phase electric for being used by the auxiliary electrical equipment of the equipment; the battery set and its management system 5 is connected in parallel with the direct current bus, to provide operating power to the gantry frequency converter 9, the hoist frequency converter 10 and the trolley frequency converter 11, and to recover the feedback energy of the three-power hybrid energy saving system; the large diesel generator set 7 has one path of output directly connected to the alternating current input end of the hoist frequency converter 10 and supply power to the direct current bus after rectification, and another path of output connected to the interconnection switch 6; the interconnection switch 6 controls switching the input power supply of the assist power supplying, is switched between being supplied by the inverter power supply 4 or being supplied by the large diesel generator set 7; the system controller 1 communicates with the battery set 5, controls the start or stop of the large and the small diesel generator sets according to the voltage, the SOC electric quantity and other parameters of the battery set, and when the system fails, judges and indicates to switch manually or automatically to the traditional operation mode in which the large diesel generator set supplies power independently.

The energy management control and the working principle of the system are herein described in detail, according to various embodiments.

When in operation, the small diesel generator set 2 may be started, and its output converted through the unidirectional AC/DC converter 3 and transmitted to the direct current bus for supplying power to the auxiliary electrical equipment and charging the battery set. When the system controller 1 detects that the SOC electric quantity of the battery set reaches the set value, working mechanisms can be put into operation;

When in operation, the actual average power demand of the work group is determined by actual working conditions such as load weight and the operating cycle frequency and the like;

If the actual average power is exactly equal to the output power of the small diesel generator set 2, the small diesel engine will output rated power for a long time, achieving the best energy efficiency, “shallow charging and shallow discharging” of the battery set 5, narrow fluctuation of the SOC electric quantity and maintenance of basic balance.

If the actual average power is larger than the output power of the small diesel generator set 2, the battery set 5 feeds electricity. When the battery set feeds electricity and the SOC electric quantity is reduced to the set value, the large diesel generator set 7 is started, and at the same time, the small diesel generator set 2 is turned off. The large diesel generator set outputs AC to the alternating current input end of the hoist frequency converter 10, and after rectification, it is transmitted to the direct current bus for being used by the equipment and charging of the battery set; when the SOC electric quantity of the battery set is increased to the set value, the large diesel generator set 7 is turned off, and at the same time, the small diesel generator set 2 is started, and it is turned back to the hybrid power operating mode with “small generator set+battery set”;

If the actual average power is smaller than the output power of the small diesel generator set 2, the electric quantity of the battery set 5 will be gradually increased. When the SOC of the battery set rises to the set value, the small diesel generator set 2 is turned off, and the RTG is powered only by the battery set; and when the SOC of the battery set decreases to the set value under the operation only by the battery, the small diesel generator set is restarted;

In the case of ship-loading or intensive pick-up operation, it always drops under a heavy load and hoists with no load, and the feedback energy is larger than the overall required energy. The electric quantity of the battery set 5 is getting higher and higher, and when the electric quantity reaches the set value, the original brake unit of the RTG is turned on, and the feedback energy is consumed by the braking resistor.

If the battery system or the inverter unit fails and cannot be recovered in a short time during operation, manually switch to supplying power by the large diesel generator set 7, and thus restore to the traditional mode operation, in which the power is supplied by a single large diesel generator set.

The three-power hybrid energy saving system for a rubber tyred gantry crane according to various embodiments may have the following characteristics.

The alternating current output by the small diesel generator set may be directly converted into direct current, wherein the output alternating current frequency is not required to be standard 50 Hz, that is, the diesel engine does not need to operate at a constant speed of 1,500 rpm, and according to the characteristics of the diesel engine itself, the small diesel generator set may be selected and controlled to work in the best economical fuel consumption zone, and under the hybrid power mode, the output power of the system is matched dynamically with the required power during the whole process, achieving the highest energy efficiency;

The large diesel generator set may be in an OFF state for a long time. It works intermittently for a short time when the actual average power is relatively large occasionally, and it will have no big effect on the overall fuel consumption; and when the hybrid power system fails, the large diesel generator set will operate, such that the reliability of the system is guaranteed;

Under the majority of operating conditions, full recovery and recycling of feedback energy for the RTG is achieved.

The battery set “charges shallowly and discharges shallowly”, which makes it have a long service life.

When the system is used for the transformation of old RTGs, there may almost be no need to make any changes to the original power system to achieve the best fuel efficiency, except that an interconnection switch is added to the auxiliary electric circuit, enabling higher generalization.

The preceding description of the disclosed embodiments is provided to enable any person skilled in the art to make or use the claims. Various modifications to these embodiments will be readily apparent to those skilled in the art, and the generic principles defined herein may be applied to some embodiments without departing from the scope of the claims. Thus, the claims are not intended to be limited to the embodiments shown herein but are to be accorded the widest scope consistent with the language of the claims and the principles and novel features disclosed herein.

What is claimed is:

1. A three-power hybrid energy saving system of a rubber tyred gantry crane, comprising:
a system controller, a small diesel generator set, a unidirectional AC/DC converter, a unidirectional DC/AC inverter power supply, a battery set and its management system, an interconnection switch, a large diesel generator set, and an auxiliary transformer, and electrical equipment of the rubber tyred gantry crane, associated with the three-power hybrid energy saving system, includes a hoist frequency converter, a trolley frequency converter, a gantry frequency converter, auxiliary electrical equipment, and a control power supply;
the small diesel generator set outputs to the unidirectional AC/DC converter, after rectification, it supplies power to a direct current bus; and the input end of the unidirectional DC/AC inverter power supply is connected in parallel with the direct current bus, after inversion, it outputs to the auxiliary transformer; and
the battery set and its management system are connected in parallel with the direct current bus, to provide operating power to the gantry frequency converter, the hoist frequency converter and the trolley frequency converter, and to recover feedback energy of the three-power hybrid energy saving system.

2. The three-power hybrid energy saving system of a rubber tyred gantry crane according to claim 1, wherein the small diesel generator set and the large diesel generator set are configured to be started independently or simultaneously, and supply power together with the battery set to the crane.

3. The three-power hybrid energy saving system of a rubber tyred gantry crane according to claim 1, wherein output power of the small diesel generator set is smaller than average power under a full load and a highest operating cycle frequency, the small diesel generator set operates for a long time or intermittently at an economic speed and outputs rated power, final energy consumption is not influenced no matter the power of the small diesel generator set is greater than or less than maximum actual average power, and optional power of the small diesel generator set is in range of 15˜75 kW.

4. The three-power hybrid energy saving system of a rubber tyred gantry crane according to claim 1, wherein one path of output of the large diesel generator set is directly connected to an alternating current input end of the hoist frequency converter, and is configured to supply power to the direct current bus after rectification, and another path of output of the large diesel generator set is connected to the interconnection switch.
